(19) United States
(12) Patent Application Publication
(10) Pub. No.: US 2026/0171685 A1
(43) Pub. Date: Jun. 18, 2026

(54) CONNECTOR

(71) Applicant: YAZAKI CORPORATION, Tokyo (JP)

(72) Inventors: Hideki Mizuno, Kakegawa-shi (JP); Masanori Nakamura, Kakegawa-shi (JP); Kento Terauchi, Kakegawa-shi (JP); Shinichi Kamura, Kakegawa-shi (JP)

(21) Appl. No.: 19/415,682

(22) Filed: Dec. 10, 2025

(30) Foreign Application Priority Data
Dec. 18, 2024 (JP) 2024-222358

(51) Int. Cl. H01R 4/30; B60L 53/16

(52) U.S. Cl. CPC H01R 4/30; B60L 53/16

(57) ABSTRACT

A connector includes a terminal, a first busbar configured to be connected to the terminal, a first fastener configured to fasten the terminal and the first busbar, a second busbar configured to be connected to the first busbar, a second fastener configured to fasten the first busbar and the second busbar, and a housing configured to accommodate the terminal. The first busbar has, at a second position to be fastened to the second fastener and connected to the second busbar, a plate thickness larger than a plate thickness of the first busbar at a first position to be fastened to the first fastener and connected to the terminal. The second position is configured to function as a heat storage portion.

### CROSS-REFERENCE TO RELATED APPLICATIONS

This application is based on and claims priority under 35 USC 119 from Japanese Patent Application No. 2024-222358 filed on Dec. 18, 2024, the entire content of which is incorporated herein by reference.

### TECHNICAL FIELD

The present disclosure relates to a connector including a terminal, a first busbar, a second busbar fastened and connected to the first busbar, and a housing accommodating the terminal.

### BACKGROUND ART

In the related art, a charging connector to be installed in a vehicle such as an electric vehicle or a plug-in hybrid vehicle has been proposed to supply (charge) electric power from outside the vehicle to a battery mounted on the vehicle as disclosed in, for example, JP2019-192482A.

Connectors of this type are generally required to have structures defined by various standards. For example, when the charging connector is actually used, the temperature (so-called operating temperature) of the terminal rises due to Joule heat generated in the terminal during energization. Accordingly, an upper limit value or the like of the operating temperature of the terminal is determined by a prescribed standard in view of quality retention, safety, and the like of the connector. Therefore, it is conceivable to provide a dedicated heat storage component that absorbs Joule heat generated during energization around the terminal or the like to reduce a degree of temperature rise of the terminal per unit time and to restrict the operating temperature of the terminal from reaching a prescribed upper limit value when an amount of heat generated by the terminal per unit time is particularly large as in fast charging. However, from a viewpoint of avoiding complicating a production process of the connector, reducing production costs, and the like, it is desirable to restrict an excessive increase in the operating temperature of the terminal without such a heat storage component.

An object of the present disclosure is to provide a connector that can restrict an excessive increase in operating temperature of a terminal without a dedicated heat storage component or the like.

To achieve the above object, the connector according to the present disclosure has following features.

### SUMMARY

A connector includes a terminal, a first busbar configured to be connected to the terminal, a first fastener configured to fasten the terminal and the first busbar, a second busbar configured to be connected to the first busbar, a second fastener configured to fasten the first busbar and the second busbar, and a housing configured to accommodate the terminal. The first busbar has, at a second position to be fastened to the second fastener and connected to the second busbar, a plate thickness larger than a plate thickness of the first busbar at a first position to be fastened to the first fastener and connected to the terminal. The second position is configured to function as a heat storage portion.

According to the connector of the present disclosure, the first busbar has, at the second position connected to the second busbar, a plate thickness larger than a plate thickness of the first busbar at the first position connected to the terminal. The second position functions as a heat storage portion. Accordingly, heat generated in the terminal is absorbed by using a part (that is, the second portion) of the first busbar originally used for energization as the heat storage portion without a dedicated heat storage component, and thereby it is possible to restrict a rapid increase in the operating temperature of the terminal and to gently increase the operating temperature of the terminal even when the amount of heat generated in the terminal per unit time is large as in fast charging. As a result, the operating temperature of the terminal can be restricted from reaching a prescribed upper limit value. Further, since the plate thickness of the second position is large, the number of components of the connector can be reduced by providing a part (for example, a screw hole) with which the second fastener is engaged in the second position without providing a mating component (for example, a nut) of the second fastener (for example, a bolt) as a separate component. Therefore, the connector of the present disclosure can restrict an excessive increase in the operating temperature of the terminal without a dedicated heat storage component or the like.

The present disclosure is briefly described above. Details of the present disclosure can be clarified by reading modes for carrying out the disclosure described below with reference to the accompanying drawings.

### BRIEF DESCRIPTION OF DRAWINGS

FIG. 1 is a perspective view of a connector according to an embodiment of the present disclosure;

FIG. 2 is an exploded perspective view of the connector illustrated in FIG. 1;

FIG. 3 is a cross-sectional view taken along a line A-A in FIG. 1;

FIG. 4 is a rear view of a first busbar on a left side illustrated in FIG. 2; and

FIG. 5 is a rear view of a second busbar illustrated in FIG. 2.

### DESCRIPTION OF EMBODIMENTS

### Embodiments

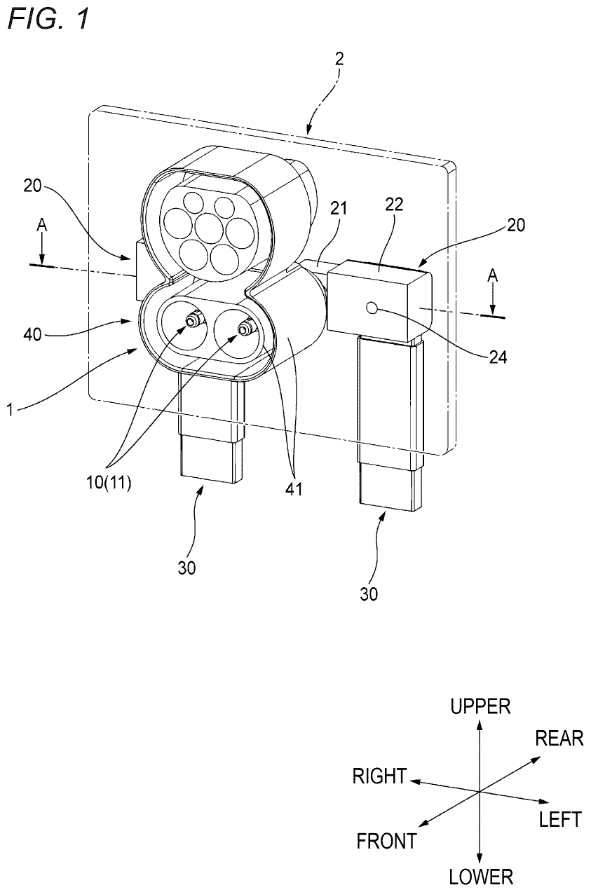

Hereinafter, a connector 1 according to an embodiment of the present disclosure will be described with reference to the drawings. The connector 1 illustrated in FIG. 1 is a charging connector (so-called charging inlet) to be installed in a vehicle such as an electric vehicle or a plug-in hybrid vehicle to supply (charge) electric power from outside the vehicle to a battery mounted on the vehicle.

Hereinafter, for convenience of description, “front”, “rear”, “upper”, “lower”, “left”, “right”, a “front-rear direction”, an “upper-lower direction”, and a “left-right direction” are defined as illustrated in FIG. 1 and the like. The “front-rear direction”, the “upper-lower direction”, and the “left-right direction” are orthogonal to one another. The left-right direction coincides with a “first direction” and a “second direction” of the present disclosure. The front-rear direction, the left-right direction, and the upper-lower direction do not necessarily have to coincide with a front-rear direction, a left-right direction, and an upper-lower direction of the vehicle or the like on which the connector 1 is mounted. Hereinafter, components constituting the connector 1 will be described in order.

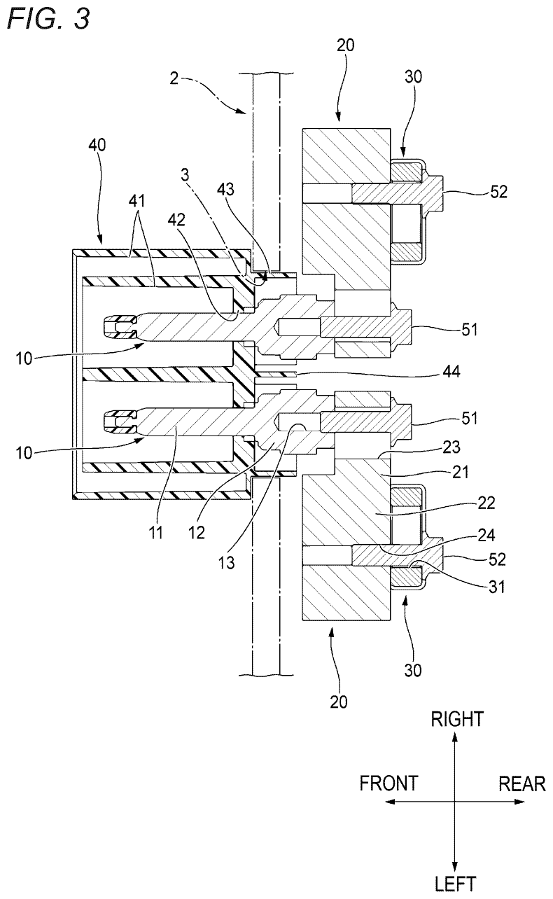

As illustrated in FIGS. 1 to 3, the connector 1 includes a pair of left and right terminals 10, a pair of left and right first busbars 20 respectively fastened to the pair of left and right terminals 10 using first bolts 51, a pair of left and right second busbars 30 respectively fastened to the pair of left and right first busbars 20 using second bolts 52, and a housing 40 accommodating the pair of left and right terminals 10. In a state in which the connector 1 is mounted on the vehicle, the connector 1 is fixed to the vehicle by the housing 40 being attached to an attachment hole 3 (see FIG. 3) formed in a plate-shaped vehicle-side member 2 (for example, a vehicle body panel; see FIGS. 1 and 3). The terminal 10 (also referred to as a power terminal) is electrically connected to a counterpart terminal (not illustrated) belonging to a counterpart connector (for example, a so-called charging connector) to be fitted to the connector 1 during battery charging, and the second busbar 30 is electrically connected to a battery side. Hereinafter, configurations of members constituting the connector 1 will be described in order.

First, the terminal 10 will be described. The pair of left and right terminals 10 are held by a pair of left and right terminal holding portions 42, which will be described later, provided in the housing 40 (see FIG. 3). As illustrated in FIG. 3, the metal terminal 10 has a rod shape extending straight in the front-rear direction as a whole, and specifically includes a small-diameter portion 11 located on a tip end side (front end side) and a large-diameter portion 12 located on a rear side (rear end side) of the small-diameter portion 11 and having a larger diameter than the small-diameter portion 11.

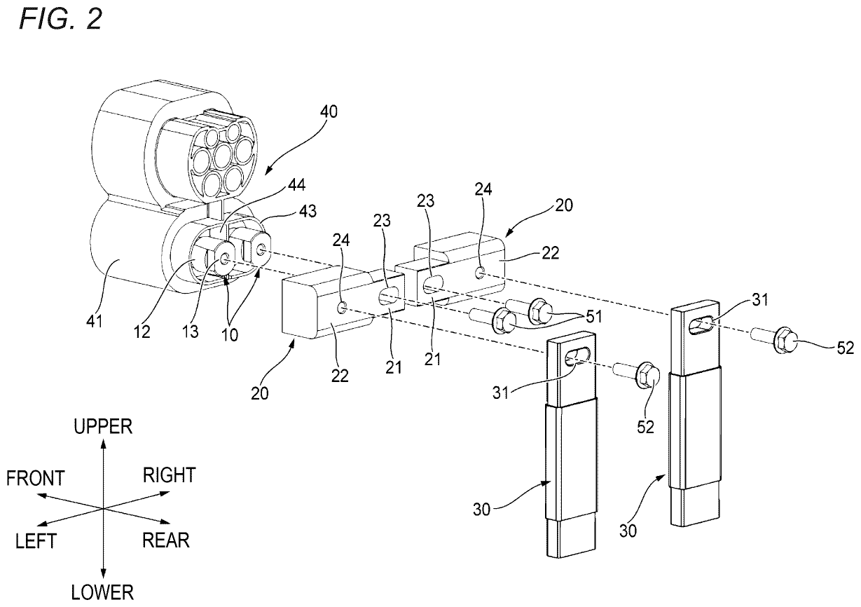

The small-diameter portion 11 is a part to be connected to the counterpart terminal belonging to the counterpart connector to be fitted to a hood portion 41 (see FIGS. 1 to 3) of the housing 40, and is a part to be held by the terminal holding portion 42 (see FIG. 3) of the housing 40. The large-diameter portion 12 is formed with, in a rear end surface thereof, a bolt hole (female screw hole) 13 recessed forward. The first busbar 20 is fastened and fixed to the rear end surface of the large-diameter portion 12 using the first metal bolt 51 screwed into the bolt hole 13 (see FIGS. 2 and 3).

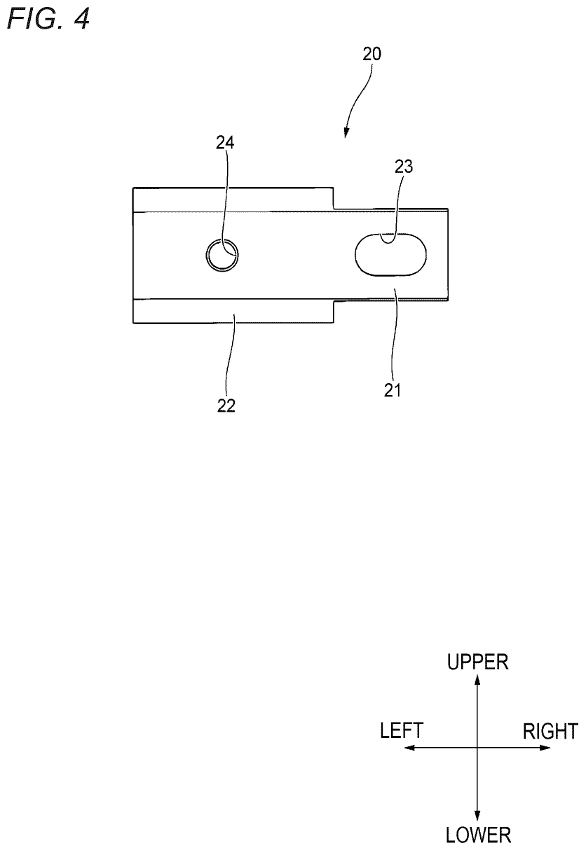

Next, the first busbar 20 will be described. The pair of left and right first busbars 20 are respectively fastened and connected to the pair of left and right terminals 10 in a state of being oriented in opposite directions in the left-right direction (see FIGS. 1 to 4). As illustrated in FIGS. 2 to 4, the first metal busbar 20 has a plate shape extending in the left-right direction as a whole, and specifically includes a fastening portion 21 located on an inner side in the left-right direction and a body portion 22 located on an outer side in the left-right direction.

The fastening portion 21 of the first busbar 20 has a substantially rectangular flat plate shape extending in the left-right direction, and is formed with a first through hole 23 running in a plate thickness direction (front-rear direction) (see FIGS. 2 to 4). Into the first through hole 23, the leg portion (male screw portion) of the first bolt 51 is inserted. The first through hole 23 has an elongated hole shape in which a hole width in the left-right direction is larger than a hole width in the upper-lower direction, so that the position of the first bolt 51 inserted into the first through hole 23 is adjustable in the left-right direction relative to the first through hole 23.

The body portion 22 of the first busbar 20 has a plate thickness (thickness in the front-rear direction) larger than a plate thickness (thickness in the front-rear direction) of the fastening portion 21 and a plate thickness (thickness in the front-rear direction) of the second busbar 30, and has a substantially rectangular flat plate shape extending in the left-right direction. The body portion 22 having a larger plate thickness also has larger heat capacity. For this reason, the body portion 22 functions as a heat storage portion that actively absorbs heat generated in the first busbar 20 during energization. When the charging connector 1 is actually used, temperature (so-called operating temperature) of the terminal 10 rises due to Joule heat generated in the terminal 10 during energization. In this regard, heat transmitting to the first busbar 20 from the terminal 10 is absorbed by the body portion 22 (heat storage portion) even when an amount of heat generated in the terminal 10 per unit time is large as in fast charging, and thereby it is possible to prevent a rapid increase in the operating temperature of the terminal 10 and to gradually increase the operating temperature of the terminal 10.

The first busbar 20 is formed with, in the body portion 22, a bolt hole (female screw hole) 24 running in the plate thickness direction (front-rear direction) (see FIGS. 1 to 4). The second busbar 30 is fastened and fixed to a rear end surface of the body portion 22 using the second metal bolt 52 screwed into the bolt hole 24 (see FIGS. 1 to 3). Since the body portion 22 has a large plate thickness, the bolt hole 24 (female screw hole), which is a part with which the second bolt 52 is engaged, can be provided in the body portion 22 without providing a counterpart component (for example, a nut) of the second bolt 52 as a separate component.

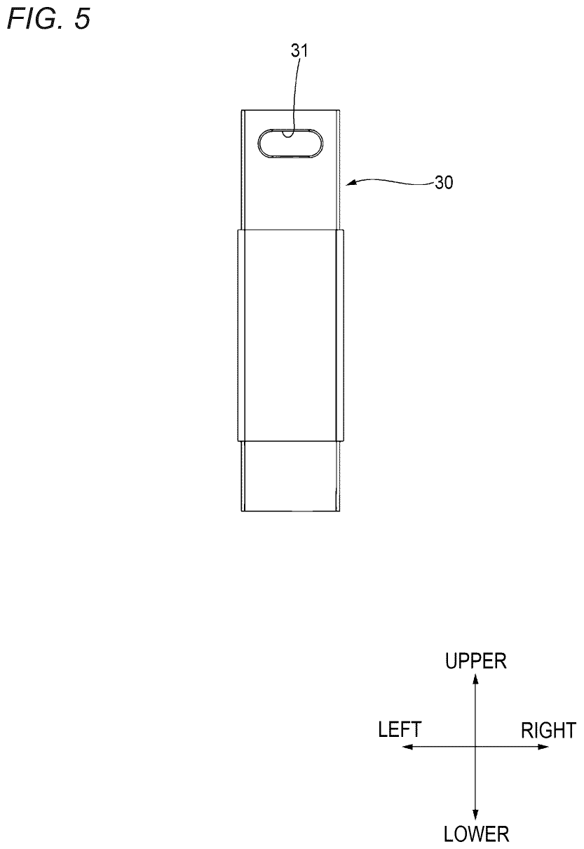

Next, the second busbar 30 will be described. The pair of left and right second busbars 30 are respectively fastened and connected to the pair of left and right first busbars 20 in a state of extending in the upper-lower direction at an interval in the left-right direction (see FIGS. 1 to 3). As illustrated in FIGS. 1 to 3 and 5, the second metal busbar 30 has a flat plate shape extending straight in the upper-lower direction as a whole. The second busbar 30 is formed with, in an upper end portion thereof, a second through hole 31 running in the plate thickness direction (front-rear direction). Into the second through hole 31, the leg portion (male screw portion) of the second bolt 52 is inserted. The second through hole 31 has an elongated hole shape in which a hole width in the left-right direction is larger than a hole width in the upper-lower direction, so that the position of the second bolt 52 inserted into the second through hole 31 is adjustable in the left-right direction relative to the second through hole 31.

Next, the housing 40 will be described. The housing 40 is attached to the attachment hole 3 of the vehicle-side member 2. The housing 40 is a resin molded body and includes the tubular hood portion 41 that has an open front end and extends in the front-rear direction, as illustrated in FIGS. 1 to 3. The hood portion 41 is a portion to which a counterpart connector is connected. As illustrated in FIG. 3, the hood portion 41 is formed with, on a rear wall that blocks a rear end thereof, the pair of left and right terminal holding portions 42. Specifically, each of the terminal holding portions 42 is a through hole extending in the front-rear direction and holds the small-diameter portion 11 of the terminal 10 (see FIG. 3). An interval between the pair of left and right terminal holding portions 42 (that is, the pair of left and right terminals 10) is set to a value corresponding to a standard applied to the connector 1.

The hood portion 41 is provided with, on a rear end surface of the rear wall blocking the rear end thereof, a tubular portion 43 protruding rearward to surround the pair of left and right terminal holding portions 42 corresponding to the attachment hole 3 of the vehicle-side member 2 (see FIGS. 2 and 3). The tubular portion 43 is inserted and fitted into the attachment hole 3 of the vehicle-side member 2 (see FIG. 3). The tubular portion 43 is provided with, at a central portion thereof in the left-right direction, a flat plate-shaped partition wall 44 extending in the upper-lower direction to divide an internal space of the tubular portion 43 into two in the left-right direction (see FIGS. 2 and 3). The members constituting the connector 1 are described above.

Next, an assembling procedure of the connector 1 will be described. To assemble the connector 1, first, the housing 40 in which the interval between the pair of left and right terminal holding portions 42 (that is, the pair of left and right terminals 10) is set to a value corresponding to a standard applied to the connector 1 is prepared, and the housing 40 is assembled to the vehicle-side member 2 from a front side (see FIG. 3). Specifically, the housing 40 is assembled to the vehicle-side member 2 such that the tubular portion 43 of the housing 40 is inserted and fitted into the attachment hole 3 of the vehicle-side member 2 and an outer peripheral edge portion of the rear wall of the hood portion 41 that is located on an outer side relative to the tubular portion 43 comes into contact with a front surface of the vehicle-side member 2.

Next, the pair of left and right terminals 10 are assembled to the housing 40 from a rear side. Specifically, each terminal 10 is inserted into the corresponding terminal holding portion 42 from the rear side, and the rear end portion of the small-diameter portion 11 is held by the corresponding terminal holding portion 42. In an assembled state of the pair of left and right terminals 10, the pair of left and right small-diameter portions 11 protrude forward from the pair of left and right terminal holding portions 42 and are located in an internal space of the hood portion 41, and the pair of left and right large-diameter portions 12 protrude rearward from the tubular portion 43 fitted in the attachment hole 3 with the partition wall 44 sandwiched in between from left and right (see FIG. 3). An order of assembling the housing 40 to the vehicle-side member 2 and assembling the terminal 10 to the housing 40 may be reversed.

Next, the pair of left and right first busbars 20 are respectively fastened to the pair of left and right terminals 10. Specifically, the leg portion of the first bolt 51 inserted into the first through hole 23 of the fastening portion 21 is screwed into the bolt hole 13 of the large-diameter portion 12 of the corresponding terminal 10 in a state in which the fastening portion 21 is located on the inner side in the left-right direction and extends in the left-right direction, and thereby the first busbar 20 is fastened to the corresponding terminal 10. At this time, the position of the first bolt 51 inserted into the first through hole 23 is adjustable in the left-right direction relative to the first through hole 23. Accordingly, by changing the position of the first bolt 51 in the left-right direction in the first through hole 23 according to an arrangement of the terminal 10, the terminal 10 and the first busbar 20 can be fastened without changing a shape of the first busbar 20 or a position of the first busbar 20 in the left-right direction even if the interval between the pair of left and right terminals 10 differs depending on the standard applied to the connector 1. Accordingly, the first busbar 20 can be shared even when the arrangement of the terminal 10 in the left-right direction differs.

Next, the pair of left and right second busbars 30 are respectively fastened to the pair of left and right first busbars 20. Specifically, the leg portion of the second bolt 52 inserted into the second through hole 31 of the second busbar 30 is screwed into the bolt hole 24 of the body portion 22 of the corresponding first busbar 20 in a state in which the second through hole 31 is located on the upper end portion and extends in the upper-lower direction, and thereby the second busbar 30 is fastened to the corresponding first busbar 20. At this time, a position of the second bolt 52 inserted into the second through hole 31 is adjustable in the left-right direction relative to the second through hole 31. Accordingly, by changing the position of the second bolt 52 in the left-right direction in the second through hole 31 according to an arrangement of the first busbar 20, the first busbar 20 and the second busbar 30 can be fastened without changing a shape of the second busbar 30 or a position of the second busbar 30 in the left-right direction even if it is necessary to change the position of the first busbar 20 in the left-right direction according to the standard applied to the connector 1. Accordingly, the second busbar 30 can be shared even when the arrangement of the first busbar 20 in the left-right direction differs. Therefore, the assembly of the connector 1 is completed, and the connector 1 illustrated in FIG. 1 is obtained.

### Operations and Effects

As described above, according to the connector 1 in the present embodiment, the first busbar 20 has, at a second position (body portion 22) connected to the second busbar 30, a plate thickness larger than a plate thickness of the first busbar 20 at a first position (fastening portion 21) connected to the terminal 10. The second position 22 functions as a heat storage portion. Accordingly, heat generated in the first busbar 20 during energization is absorbed by the body portion 22 having a large heat capacity without a dedicated heat storage component, and thereby it is possible to restrict a rapid increase in the operating temperature of the terminal 10 and to gently increase the operating temperature of the terminal 10 even when the amount of heat generated in the terminal 10 per unit time is large as in fast charging. Accordingly, the operating temperature of the terminal 10 can be restricted from reaching a prescribed upper limit value. Further, since the plate thickness of the second position 22 is large, a part (bolt hole 24) with which the second fastener 52 is engaged can be provided at the second position 22 without providing a counterpart component (for example, a nut) of the second fastener (second bolt 52) as a separate component. Therefore, the connector 1 according to the present embodiment can restrict an excessive increase in the operating temperature of the terminal 10 without a dedicated heat storage component or the like.

Further, according to the connector 1 in the present embodiment, the first through hole 23 of the first busbar 20 for inserting the first fastener (first bolt 51) has an elongated hole shape elongated in a first direction (left-right direction), and the second through hole 31 of the second busbar 30 for inserting the second fastener 52 has an elongated hole shape elongated in a second direction (left-right direction). For this reason, even if the arrangement of the terminal 10 differs depending on the standard applied to the connector 1, by changing the position of the first fastener 51 in the first through hole 23 according to the arrangement of the terminal 10, the terminal 10 and the first busbar 20 can be fastened without changing the shape of the first busbar 20 or the position of the first busbar 20 in the housing 40. Even if it is necessary to change the position of the first busbar 20, by changing the position of the second fastener 52 in the second through hole 31 according to the arrangement of the first busbar 20, the first busbar 20 and the second busbar 30 can be fastened without changing the shape of the second busbar 30 or the position of the second busbar 30 in the housing 40. Therefore, the connector 1 according to the present embodiment can share the first and second busbars 20, 30 even if the arrangement of the terminal 10 differs.

According to the connector having the configuration of [3], the pair of terminals 10 are arranged side by side in the direction in which the first through hole 23 of the first busbar 20 extends (that is, the first direction). Accordingly, even if the interval between the pair of terminals 10 differs depending on a standard, the terminals 10 and the first busbar 20 can be fastened without changing the shape of the first busbar 20 or the position of the first busbar 20 in the housing 40.

### Other Embodiments

The present disclosure is not limited to the embodiment described above, and various modifications can be adopted within the scope of the present disclosure. For example, the present disclosure is not limited to the embodiment described above, and modifications, improvements, and the like can be appropriately made. In addition, materials, shapes, sizes, numbers, arrangement positions, and the like of components in the embodiment described above are freely selected and are not limited as long as the present disclosure can be implemented.

In the above embodiment, since the first through hole 23 of the first busbar 20 has an elongated hole shape elongated in the left-right direction, the position of the first bolt 51 inserted into the first through hole 23 is adjustable in the left-right direction relative to the first through hole 23, and since the second through hole 31 of the second busbar 30 has an elongated hole shape elongated in the left-right direction, the position of the second bolt 52 inserted into the second through hole 31 is adjustable in the left-right direction relative to the second through hole 31. On the other hand, although the first through hole 23 of the first busbar 20 has an elongated hole shape elongated in the left-right direction so that the position of the first bolt 51 inserted into the first through hole 23 is adjustable in the left-right direction relative to the first through hole 23, the second through hole 31 of the second busbar 30 may have an elongated hole shape elongated in the upper-lower direction so that the position of the second bolt 52 inserted into the second through hole 31 is adjustable in the upper-lower direction relative to the second through hole 31.

Here, features of the embodiment of the connector 1 according to the present disclosure described above are briefly summarized and listed in following [1] to [3].

### First Aspect

A connector (1) includes, a terminal (10), a first busbar (20) configured to be connected to the terminal (10), a first fastener (51) configured to fasten the terminal (10) and the first busbar (20), a second busbar (30) configured to be connected to the first busbar (20), a second fastener (52) configured to fasten the first busbar (20) and the second busbar (30), and a housing (40) configured to accommodate the terminal (10). The first busbar (20) has, at a second position (22) to be fastened to the second fastener (52) and connected to the second busbar (30), a plate thickness larger than a plate thickness of the first busbar (20) at a first position (21) to be fastened to the first fastener (51) and connected to the terminal (10). The second position (22) is configured to function as a heat storage portion.

According to the connector having the configuration of the first aspect, the first busbar has, at the second position connected to the second busbar, a plate thickness larger than a plate thickness of the first busbar at the first position connected to the terminal. The second position functions as a heat storage portion. Accordingly, heat generated in the terminal is absorbed by using a part (that is, the second portion) of the first busbar originally used for energization as the heat storage portion without a dedicated heat storage component, and thereby it is possible to restrict a rapid increase in the operating temperature of the terminal and to gently increase the operating temperature of the terminal even when the amount of heat generated in the terminal per unit time is large as in fast charging. As a result, the operating temperature of the terminal can be restricted from reaching a prescribed upper limit value. Further, since the plate thickness of the second position is large, a part (for example, a bolt hole) with which the second fastener is engaged is provided in the second position without providing a counterpart component (for example, a nut) of the second fastener (for example, bolt) as a separate component, and thereby the number of components of the connector can be reduced. Therefore, the connector having the present configuration can restrict an excessive increase in the operating temperature of the terminal without a dedicated heat storage component or the like.

### Second Aspect

In the connector (1) according to the first aspect, a first through hole (23) that is provided in the first position (21) and through which the first fastener (51) is configured to be inserted has an elongated hole shape in which a hole width in a prescribed first direction is larger than a hole width in a direction intersecting the first direction, and allows a position of the first fastener (51) in the first through hole (23) to be adjustable in the first direction. A second through hole (31) that is provided in the second busbar (30) and through which the second fastener (52) is configured to be inserted has an elongated hole shape in which a hole width in a prescribed second direction is larger than a hole width in a direction intersecting the second direction, and allows a position of the second fastener (52) in the second through hole (31) to be adjustable in the second direction.

According to the connector having the configuration of the second aspect, the first through hole of the first busbar for inserting the first fastener has an elongated hole shape elongated in the first direction, and the second through hole of the second busbar for inserting the second fastener has an elongated hole shape elongated in the second direction. For this reason, even if the arrangement of the terminal differs depending on the standard applied to the connector, by changing the position of the first fastener in the first through hole according to the arrangement of the terminal, the terminal and the first busbar can be fastened without changing the shape of the first busbar or the position of the first busbar in the housing.

Even if it is necessary to change the position of the first busbar, by changing the position of the second fastener in the second through hole according to the arrangement of the first busbar, the first busbar and the second busbar can be fastened without changing the shape of the second busbar or the position of the second busbar in the housing. Therefore, the connector having the present configuration can share the internal busbars even if the arrangement of the terminal differs.

### Third Aspect

In the connector (1) according to the second aspect, a pair of the terminals (10) are configured to be arranged side by side in the first direction.

According to the connector having the configuration of the third aspect, the pair of terminals are arranged side by side in the direction in which the first through hole of the first busbar extends (that is, the first direction). Accordingly, even if the interval between the pair of terminals differs depending on a standard, the terminals and the first busbar can be fastened without changing the shape of the first busbar or the position of the first busbar in the housing.

What is claimed is:

1. A connector comprising:
a terminal;
a first busbar configured to be connected to the terminal;
a first fastener configured to fasten the terminal and the first busbar;
a second busbar configured to be connected to the first busbar;
a second fastener configured to fasten the first busbar and the second busbar; and
a housing configured to accommodate the terminal,
wherein the first busbar has, at a second position to be fastened to the second fastener and connected to the second busbar, a plate thickness larger than a plate thickness of the first busbar at a first position to be fastened to the first fastener and connected to the terminal, and
wherein the second position is configured to function as a heat storage portion.

2. The connector according to claim 1,
wherein a first through hole that is provided in the first position and through which the first fastener is configured to be inserted has an elongated hole shape in which a hole width in a prescribed first direction is larger than a hole width in a direction intersecting the first direction, and allows a position of the first fastener in the first through hole to be adjustable in the first direction, and
wherein a second through hole that is provided in the second busbar and through which the second fastener is configured to be inserted has an elongated hole shape in which a hole width in a prescribed second direction is larger than a hole width in a direction intersecting the second direction, and allows a position of the second fastener in the second through hole to be adjustable in the second direction.

3. The connector according to claim 2,
wherein the pair of terminals are configured to be arranged side by side in the first direction.
